(19) United States
(12) Patent Application Publication
(10) Pub. No.: US 2005/0046709 A1
(43) Pub. Date: Mar. 3, 2005

(54) Imaging apparatus and data management method therefor

(76) Inventor: Norio Nagai, Saitama (JP)

Correspondence Address: BIRCH STEWART KOLASCH & BIRCH, PO BOX 747, FALLS CHURCH, VA, 22040-0747, US

(21) Appl. No.: 10/929,427

(22) Filed: Aug. 31, 2004

(30) Foreign Application Priority Data
Sep. 1, 2003 (JP) 2003-309215

(51) Int. Cl. H04N 5/76

(52) U.S. Cl. 348/231.8

(57) ABSTRACT

Memory cards are respectively set in first and second slots to take a moving image. A memory controller records image data, which is produced from the taken image, in the memory card of the first slot. When available memory of this memory card runs out, the data is continuously recorded in the switched memory card of the second slot. While recording the data in the memory card of the second slot, the memory card of the first slot is exchanged to another one having available memory. When the available memory of the memory card of the second slot runs out, the data is continuously recorded in the switched memory card of the first slot again. Switching the slot and exchanging the memory card are alternately performed so that the moving image may be taken for a long time.

### BACKGROUND OF THE INVENTION

1. Field of the Invention

The present invention relates to an imaging apparatus provided with a plurality of slots for setting recording media, and further relates to a data management method for the imaging apparatus.

2. Description of the Related Art

A digital camera in which digital image data is recorded in a memory is widely used. In this kind of the digital camera, a CCD solid-state imaging device takes a subject image formed by an imaging optical system. The digital image data is produced from an analog signal outputted from the CCD solid-state imaging device. In the digital camera, a memory card of a small cartridge is used as a recording medium for recording the image data. The memory card has a nonvolatile memory incorporated therein.

The digital camera is provided with a slot into which the memory card is inserted. A connector for connecting with a connection terminal of the memory card is incorporated in the slot. The image data is read from and written into the memory card by a memory controller connected to the connector. The slot is provided with a lid for opening and closing the slot in order to prevent dust or the like from entering the inside. Further, an ejecting mechanism is also provided to pop the edge of the memory card out of the slot at the time of ejecting the memory card from the slot. Thus, the memory card is easily pulled out.

Some of the digital cameras are provided with a plurality of slots (see Japanese Patent Laid-Open Publication Nos. 2000-295579 and 2002-112085, for example). The digital camera described in the Publication No. 2000-295579 switches the slot to be used in accordance with contents of the image data. Meanwhile, the digital camera described in the Publication No. 2002-112085 reduces power consumption by turning off the power supply of the slot during a non-operational state.

The CCD solid-state imaging device has been improved so as to increase a pixel number. Many digital cameras are capable of photographing not only a static image but also a long-time moving image. Consequently, a size of an image file becomes large so that a number of the image files to be recorded in one memory card is reduced. Especially, when photographing the moving image, a photographable time in succession is restricted by capacity of the memory card. In view of this, it is desired to increase the storage capacity of the memory card. However, there are limits to increase the capacity. Further, the memory card having large capacity is very expensive.

### SUMMARY OF THE INVENTION

In view of the foregoing, it is a primary object of the present invention to provide an imaging apparatus and a data management method therefor, in which it is possible to increase memory capacity at low cost.

In order to achieve the above and other objects, the data management method for the imaging apparatus according to the present invention comprises a step of monitoring available memory of a recording medium while image data is recorded therein. When the available memory of the recording medium set in one slot has run out, the currently recorded image data is successively recorded in another recording medium set in the other slot. As to image files including the image data having been continuously recorded in the plural recording media, related file names are given thereto.

Moreover, the data management method comprises a step of monitoring a readout status of the recording medium while the image data is read out. When the image data has been fully read out of the recording medium set in one slot, it is commenced to read the image data from the recording medium set in the other slot.

While the image data is recorded and is read out, the recording medium of a non-operational state becomes exchangeable.

The imaging apparatus according to the present invention comprises a power control unit. When the recording medium is exchanged, the power control unit stops supplying a power to the slot in which the recording media to be exchanged is set. The imaging apparatus further comprises a display for indicating the slot of which the recording medium is exchangeable.

The imaging apparatus further comprises a media protector which prevents the recording medium from being ejected during access. The media projector allows ejecting the recording medium of the non-operational state from the slot. The media protector is constituted of lids, lid-operating mechanisms and a controller. The lid opens and closes an inlet of each slot. The lid-operating mechanisms open and close the respective lids. The controller actuates the lid-operating mechanism of the slot, in which the recording medium of the non-operational state is set, to open the lid thereof. Incidentally, the opened lid is adapted to be closed after a predetermined period.

The imaging apparatus further comprises an ejector for ejecting the recording medium of the non-operational state from the slot. The ejector is constituted of ejecting mechanisms and an ejection controller. The ejecting mechanism ejects the recording medium from each slot. The ejection controller actuates the ejecting mechanism of the slot, in which the recording medium of the non-operational state is set, to eject the recording medium from the slot.

According to the data management method of the present invention, the large-sized image data is continuously recorded in the plural recording media. Thus, it is possible to take a moving image for a long time without using a recording medium having large capacity. As to the image data continuously recorded in the plural recording media, the file names for representing the mutual relation are given thereto. In virtue of this, the image data is easily dealt with after taking the image.

The image data is successively read out of the plural recording media. Thus, when the image data of the plural recording media is reproduced, changing the recording media is reduced.

The recording medium of the non-operational state can be exchanged while taking the image. Thus, it is possible to take the image for a long time by a number of the recording media or as long as a power source endures.

According to the imaging apparatus of the present invention, power supply is stopped relative to the slot in which the recording medium to be exchanged is set. Thus, the recording medium is prevented from being damaged. Further, since the slot of which the recording medium is exchangeable is indicated, the recording medium is prevented from being mistakenly exchanged during data access.

Only the recording medium of the non-operational state is adapted to be exchangeable so that the recording medium is prevented from being mistakenly exchanged during data access. Further, since the lid for opening and closing the slot is utilized as the media protector, a space for attachment and its cost may be reduced. Furthermore, since the lid is automatically closed after the predetermined period, breakage caused by forgetting to close the lid is prevented and dust is prevented from entering the slot.

Only the recording medium of the non-operational state is ejected from the slot at the time of medium exchange so that the recording medium is prevented from being mistakenly exchanged during data access.

### BRIEF DESCRIPTION OF THE DRAWINGS

The above objects and advantages of the present invention will become apparent from the following detailed description of the preferred embodiments of the invention when read in conjunction with the accompanying drawings, in which:

FIGS. 1A and 1B are perspective views showing a digital camera according to the present invention;

FIG. 2 is a partial perspective view showing a structure of a slot;

FIG. 3 is a block diagram showing a structure of the digital camera;

FIG. 4 is a block diagram showing a structure of a recorder;

FIG. 5 is an exploded perspective view showing a structure of a lid-opening mechanism;

FIGS. 6A and 6B are partial section views explaining an operation of the lid-opening mechanism;

FIG. 7 is a flowchart showing a sequence of a photography mode for taking a moving image for a long time;

FIG. 8 is a flowchart showing a sequence for exchanging a memory card;

FIG. 9 is an explanatory illustration showing contents displayed on a monitor at the time of the long-time photography mode;

FIG. 10 is an explanatory illustration showing the memory card used for the long-time photography mode; and

FIG. 11 is a flowchart showing a sequence of a successive reproduction mode.

### DETAILED DESCRIPTION OF THE PREFERRED EMBODIMENT(S)

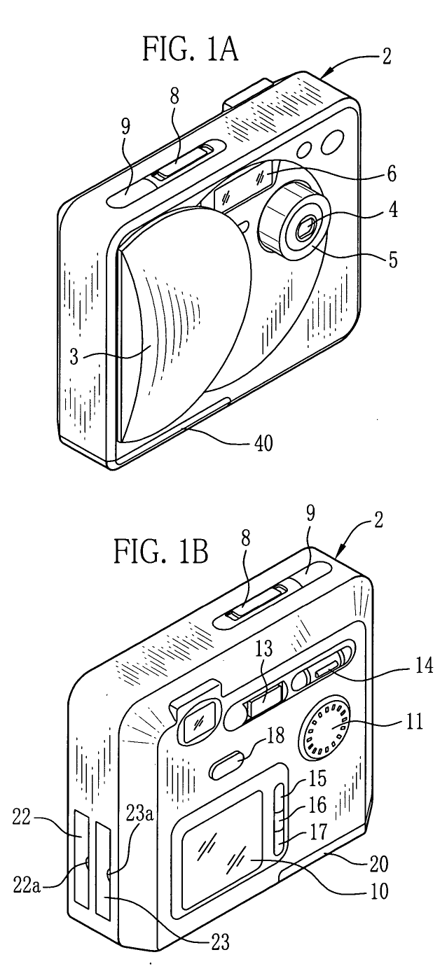

FIGS. 1A and 1B are perspective views showing an exterior of a digital still camera 2 according to the present invention. A lens cover 3 is attacked to the front of the digital still camera (hereinafter, simply called as camera) 2. The lens cover 3 is slidable in a horizontal direction and has a semicircular shape. When the camera 2 is not used and is set in a reproduction mode, the lens cover 3 is slid to a closed position, which is a right side in the drawing, to protect the front of the camera. Meanwhile, when photographing is performed with the camera 2, the lens cover 3 is slid to an open position, which is a left side in the drawing, to expose a flash 6 and a lens barrel 5 containing a taking lens 4.

An upper surface of the camera 2 is provided with a power switch 8 and a shutter button 9. The power switch 8 turns on and off a power supply of the camera 2 in association with a horizontal slide operation. The shutter button 9 performs shutter release upon a vertical depression operation. A rear surface of the camera 2 is provided with a display monitor 10 and an audio output portion 11 comprising a speaker. The display monitor 10 comprises a color LCD panel to reproduce a taken image data. The display monitor 10 is also used as a view finder at the time of photographing. Further, the display monitor 10 shows various setting items, photographic data, various messages for a user, and so forth.

On the rear surface of the camera 2, are disposed various operation members of a mode operation member 13, a four-way key 14, a cancel button 15, a menu button 16, a display button 17, a media exchange button 18 and so forth. The mode operation member 13 is horizontally slidable and changes an operation mode of the camera 2 in accordance with a slide position thereof. The camera 2 of this embodiment is provided with a “normal photography mode” for taking a moving image with a single memory card, a “long-time photography mode” for taking a long moving image with a plurality of memory cards, a “normal reproduction mode” for reproducing a taken still image and the taken moving image, a “successive reproduction mode” for successively reproducing the data stored in the memory cards, and a “still-image photography mode” for taking a still image.

The bottom of the camera 2 is provided with a battery chamber for containing a battery constituting a power source. The battery chamber is closed with an openable battery lid 20.

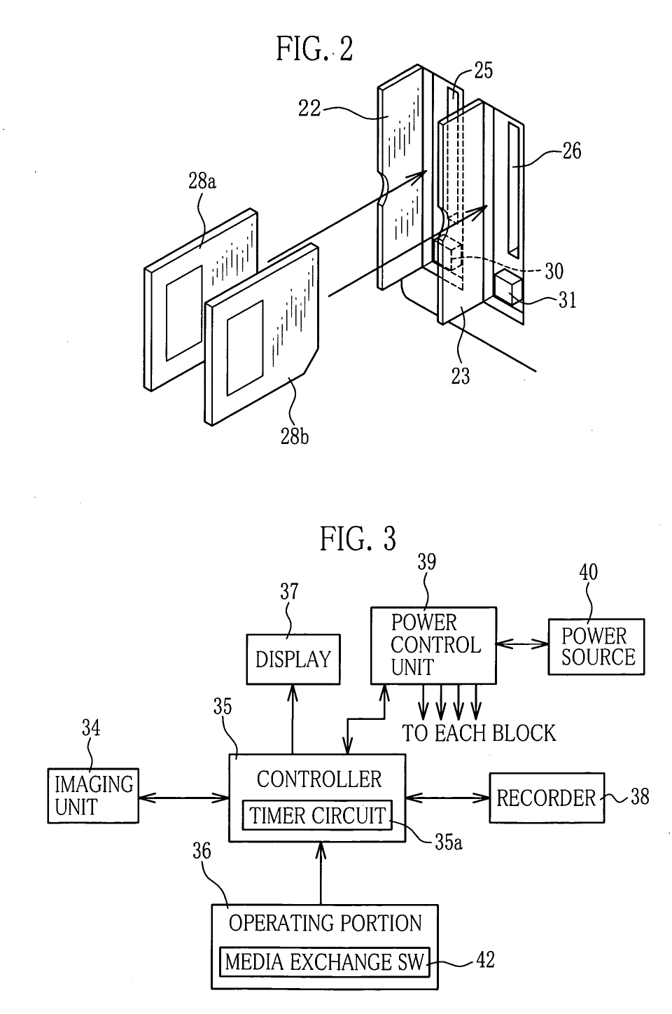

Such as shown in FIG. 2, a lateral side of the camera 2 is provided with a first slot 25 and a second slot 26, which are opened and closed by a first lid 22 and a second lid 23 respectively. A well-known memory card 28 is inserted, as a recording medium, into the respective slots 25 and 26. Eject buttons 30 and 31 are provided under the slots 25 and 26. The eject buttons 30 and 3l are pushed when ejecting the memory card 28 from the respective slots 25 and 26.

Upon pressing the media exchange button 18, the lid of the slot of a non-operational state is automatically opened. While opening the lid, the memory card is set, removed and exchanged. The opened lid is automatically closed after a predetermined period, for instance, after ten seconds.

Under the long-time photography mode, a moving-image file is continuously recorded in the memory cards set in both of the slots 25 and 26. While the moving-image file is recorded in the memory card set in one of the slots, it is possible to exchange the memory card set in the other slot. Thus, the moving image may be taken for a long time under the long-time photography mode. Meanwhile, under the successive reproduction mode, the data stored in the memory cards set in both of the slots 25 and 26 are successively reproduced. While the data is read from the memory card set in one of the slots, it is possible to exchange the memory card set in the other slot. Thus, the data stored in many memory cards may be successively reproduced under the successive reproduction mode.

FIG. 3 is a block diagram showing a structure of the camera 2 comprising an imaging unit 34, a controller 35, an operating portion 36, a display 37, a recorder 38 and a power control unit 39. The imaging unit 34 takes a subject image to produce image data. The controller 35 controls the whole of the camera 2. The operating portion 36 inputs operations, performed on the camera 2, into the controller 35. The display 37 shows a taken image, various setting items and so forth. The recorder 38 records the image data in the memory card. The power control unit 39 controls electric power to be supplied to each block. The power control unit 40 is connected to a power source 40 including the battery set in camera 2.

The imaging unit 34 comprises the taking lens 4, a stop mechanism, a CCD solid-state imaging device, an image processing circuit and so forth. The image processing circuit converts an analog signal outputted from the CCD solid-state imaging device, into digitized image data. The image processing circuit also executes various correction processes. The controller 35 comprises a CPU, a ROM storing a control program and control data, a RAM temporarily storing the image data, and so forth. Moreover, the controller 35 is also provided with a timer circuit 35a for measuring an open time of the respective lids 22 and 23.

The operating portion 36 includes many switches, which are incorporated so as to correspond to various operation members of the power switch, the shutter button 9 and so forth. The operating portion 36 also includes a media exchange switch 42 to be turned on and off by pressing the media exchange button 18. The display 37 comprises a color LCD panel constituting the display monitor 10, an LCD driver for controlling the color LCD panel, an encoder for encoding the image data and converting it into a composite signal, and so forth.

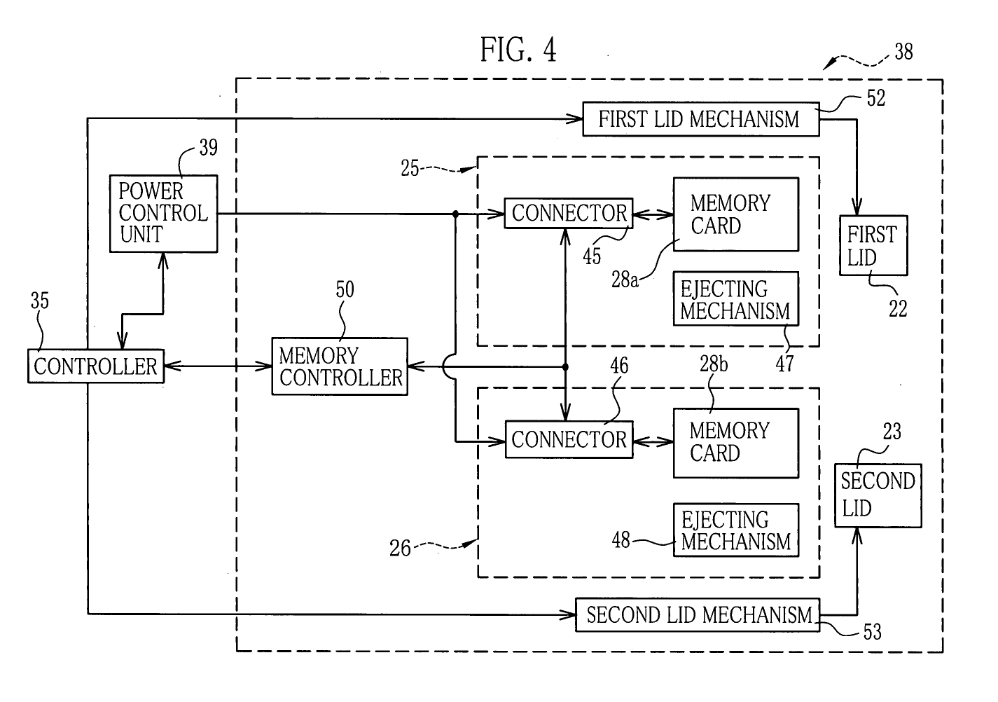

FIG. 4 is a block diagram showing a structure of the recorder 38 including the first slot 25 and the second slot 26. The first slot 25 and the second slot 26 are provided with connectors 45 and 46 for electrically connecting with the memory cards 28a and 28b, and ejecting mechanisms 47 and 48 for ejecting the memory cards 28a and 28b from the slots 25 and 26 in association with handling of the eject buttons 30 and 31. As well known, the ejecting mechanisms 47 and 48 change an operational direction of pressing action of the eject buttons 30 and 31 by utilizing the principle of leverage to eject the memory cards 28a and 28b from the slots 25 and 26.

The connectors 45 and 46 are connected to a memory controller 50 being as media control means. The memory controller 50 connects with the memory cards 28a and 28b via the connectors 45 and 46 to write and read the image data and to monitor a data-readout status and a space of the memory card 28. When a single moving-image file is recorded in the plural memory cards 28 under the long-time photography mode, the moving-image file is divided and recorded in the respective memory cards. Further, a file name is given to each of the divided moving-image files so as to clarify a relation among the respective files.

The power is supplied from the power control unit 39 to the connectors 45 and 46. Incidentally, when the memory card is set to the slot and when the memory card is ejected and exchanged, the power control unit 39 stops supplying the power to the slot concerned.

A first lid mechanism 52 and a second lid mechanism 53 for opening and closing the first lid 22 and the second lid 23 are incorporated near the first slot 25 and the second slot 26. FIG. 5 is an exploded perspective view showing a structure of the first lid 22 and the first lid mechanism 52. The edge of the first lid 22 is formed with a cylindrical pivot 55 being as the rotational center at the time of opening and closing. Into the pivot 55, is inserted a metal shaft 56 for rotatably attaching the first lid 22 to the camera 2.

An upper portion of the pivot 55 of the first lid 22 is formed with a spring hook piece 59 on which one end of a torsion spring 58 is put. The torsion spring 58 into which the shaft 56 is inserted is attached to the upper portion of the first lid 22. The other end of the torsion spring 58 is put on a pin, which is disposed at a camera-body side and is not shown, to urge the first lid 22 in a closing direction.

A pressed piece 61 having an L-like shape is disposed near the middle of the pivot 55. The pressed piece 61 is pushed when opening the first lid 22. An actuator 62 is disposed at a lateral side of a pin 61a formed on the pressed piece 61. The actuator 62 protrudes an L-shaped shaft 62a when a current is applied. When the current is not applied, the actuator 62 retracts the shaft 62a.

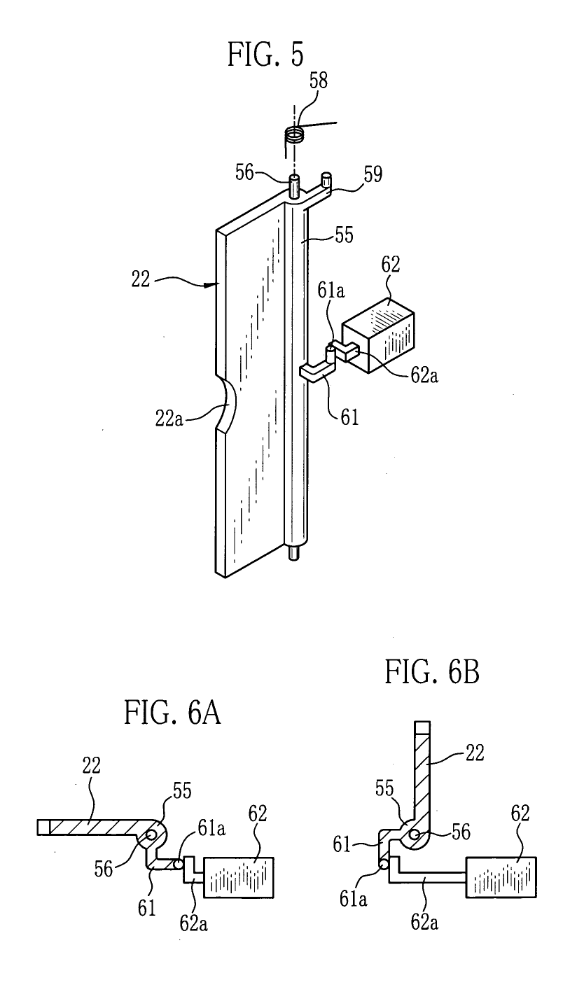

Such as shown in FIG. 6A, the shaft 62a is retracted in the body of the actuator 62 when the actuator 62 is in the non-electrified state. In this state, the first lid 22 is kept in a closed position by means of the torsion spring 58. When the actuator 62 is in an electrified state, the shaft 62a is protruded from the body of the actuator 62, such as shown in FIG. 6B. The protruded shaft 62a pushes the pressed piece 61 to rotate the first lid 22 to an open position against an urging force of the torsion spring 58. When the current applied to the actuator 62 is stopped, the shaft 62a is retracted into the body of the actuator 62 so that the lid 22 is rotated to the closed position by the urging force of the torsion spring 58.

The second slot 26 is provided with the lid mechanism 53 having a structure identical with the above. Both of the actuator 62 and an actuator of the second slot 26 are controlled by the controller 35. When the media exchange button 18 is pressed and an operation signal thereof is inputted, the controller 35 electrifies the actuator of the slot of a non-operational state. After electrifying the actuator, the controller 35 commences clocking with the timer circuit 35a. When ten seconds have passed, electrifying the actuator is stopped to close the lid. As to the slot in which the image data is currently recorded in and currently read from the memory card 28, the lid thereof is not opened so that it is prevented to eject the memory card during the access. Consequently, it is provided to damage the data.

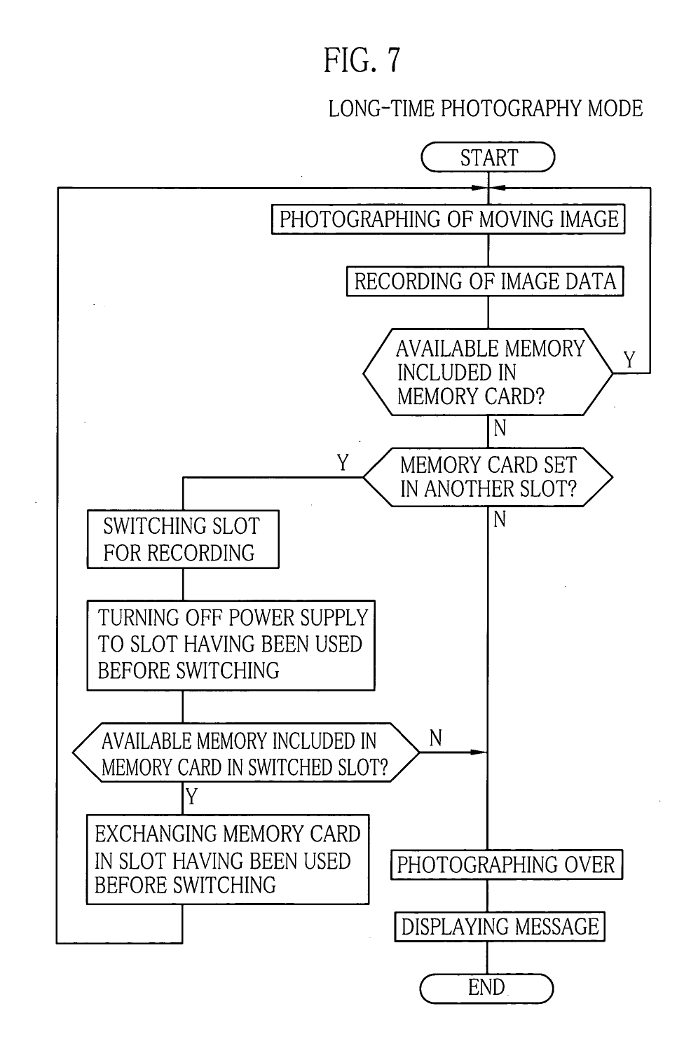

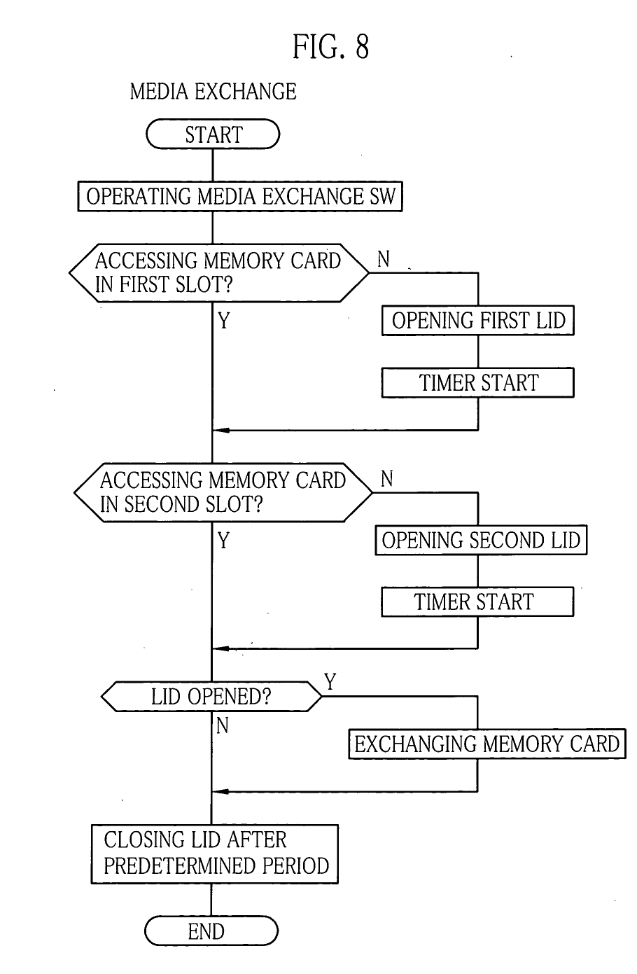

Next, the long-time photography mode of the camera 2 of the above embodiment is described below, referring to flowcharts shown in FIGS. 7 and 8. When the moving image is taken for a long time, it is necessary to prepare the memory cards, in advance, having available memory. For example, when the long moving image is taken by using five memory cards 28a to 28e, first of all, the memory cards 28a and 28b are respectively inserted into the first slot 25 and the second slot 26 of the camera 2.

When the power supply of the camera 2 is turned off, the first lid 22 and the second lid 23 are not opened if the media exchange button 18 is operated. So, the lids 22 and 23 are manually opened by utilizing cutouts 22a and 23a formed in the respective lids 22 and 23. And then, the memory cards 28a and 28b are set to the first slot 25 and the second slot 26. Meanwhile, when the memory cards 28a and 28b are set in a state that the power supply is turned on, setting these cards are performed while the first lid 22 and the second lid 23 are opened for the predetermined period by operating the media exchange button 18.

After setting the memory cards 28a and 28b, the long-time photography mode is determined by handling the mode operation member 13. Upon holding the camera 2 and depressing the shutter button 9, moving-image photography is commenced. The imaging unit 34 converts a subject image, which is taken by the CCD solid-state imaging device, into digital image data to be recorded in the RAM of the controller 35. The memory controller 50 of the recorder 38 reads the image data from the RAM to record it in the memory card 28a set in the first slot 25. Further, the memory controller 50 monitors the available memory of the memory card 28a.

Incidentally, the power control unit 39 stops supplying the power to the second slot 26 of the non-operational state while the first slot 25 is operated. Thus, the second slot 26 is in an off-state. By the way, regarding the slot to be used first for recording the image data, priority may be determined in advance. In another way, the slot to be used first may be determined in accordance with the capacity of the memory card. Further, the user may designate the slot before photographing.

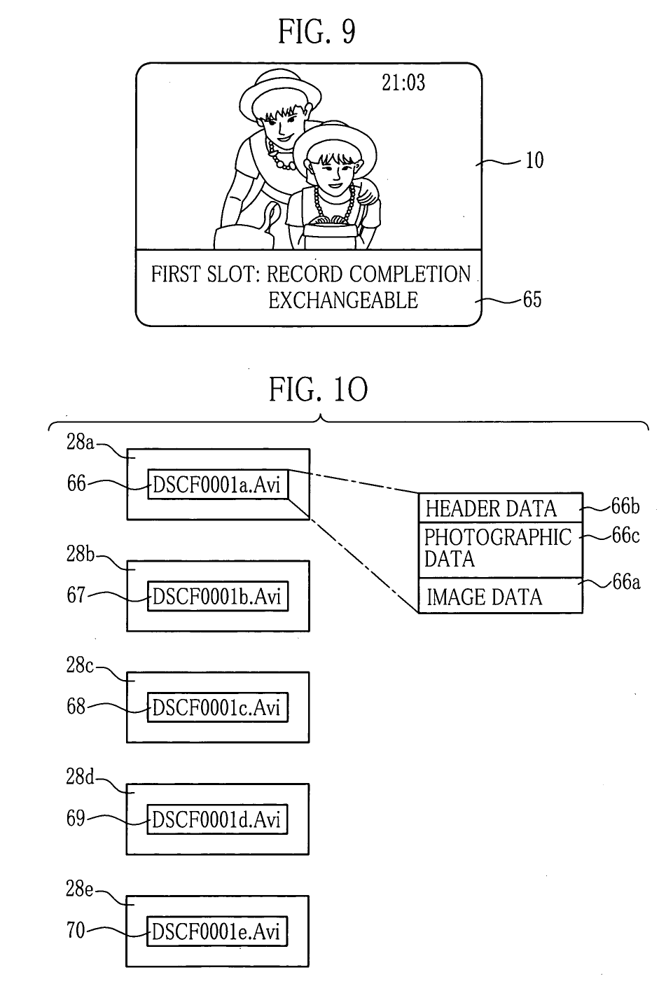

When the long moving image is taken with the exchange of the memory card, sometimes it becomes difficult to specify the slot for exchanging the memory card next. In view of this, it is preferable to provide a message area 65 under the moving image, which is currently taken and is shown on the display monitor 10, such as illustrated in FIG. 9 for example. The message area 65 indicates “FIRST SLOT: RECORD COMPLETION, EXCHANGEABLE”. Further, the message area 65 may indicate the remaining available memory, such as “AVAILABLE MEMORY OF FIRST SLOT: 28 MB”. By this indication, it becomes possible to anticipate the time for exchanging the memory card.

When the available memory of the memory card 28a of the first slot 25 draws to an end, the power control unit 39 commences to supply the power to the second slot 26 so that preparation for recording the data in the memory card 28b is commenced. When the available memory of the memory card 28a has run out, the memory controller 50 switches the memory card so as to record the image data in the memory card 28b. In this way, the image data is continuously recorded relative to the plural memory cards. Thus, it is possible to extend a period for taking the moving image in accordance with a number of the slots.

Further, the memory controller 50 adds header data and photographic data to the image data of the memory card 28a to produce the moving-image file to which a file name of DSCF0001a. Avi is given. After that, the power control unit 39 stops supplying the power to the first slot 25 to set this slot 25 in the off-state. In this way, the power supply of the slot, which is loaded with the recorded memory card, is turned off. Thus, when the memory card is exchanged, the data recorded in the memory card is prevented from being damaged due to short circuit with the connector.

By the way, in case the memory card is not set in the slot to be used next when the slot for recording is switched, photographing is terminated and this situation is indicated on the display monitor 10. Even if the memory card is set in the slot to be used next, photographing is similarly terminated and this situation is indicated on the display monitor 10 when the set memory card lacks the available memory.

After completing the record of the memory card 28a of the first slot 25, the display monitor 10 indicates the message of “FIRST SLOT: RECORD COMPLETION, EXCHANGEABLE”. The user confirms this message and operates the media exchange button 18. The controller 35 controls the power control unit 39 in response to the operation signal inputted from the media exchange switch 42 to electrify the actuator 62 of the first slot 25. Simultaneously, the timer circuit 35a is activated to start clocking.

As described above, the memory card is exchanged by confirming the message indicated on the display monitor 10. In virtue of this, it is prevented to overlook the time for exchanging the memory card. Moreover, the slot of which the memory card is exchangeable becomes definite so that it is prevented to mistakenly exchange the memory card of the other slot.

As shown in FIGS. 5 and 6, the electrified actuator 62 pushes the pressed piece 61 with the protruded shaft 62a to open the first lid 22. While opening the first lid 22, the user operates the eject button 30 to eject the memory card 28a. And then, the user sets the next memory card 28c. After measuring ten seconds with the timer circuit 35a, electrifying the actuator 62 is terminated to retract the shaft 62a so that the first lid 22 is closed by the urging force of the torsion spring 58.

In this way, only the lid of the slot of which the memory card is exchangeable is adapted to be opened. Thus, it is prevented to mistakenly exchange the memory card of the slot being used for recording. Further, the lids 22 and 23 are automatically closed when the predetermined period has passed after opening the lids 22 and 23. Therefore, damage to be caused by forgetting to close the lids 22 and 23 may be prevented, and dust may be prevented from entering the slots 25 and 26.

When the available memory of the memory card 28b of the second slot 26 runs out, the image data is continuously recorded in the switched memory card 28c of the first slot 25. Meanwhile, in the memory card 28b of the second slot 26, header data and photographic data are added to the image data to produce the image file to which a file name of “DSCF0001b.Avi”, for example, is given. Then, the power supply of the second slot 26 is turned off so that it becomes possible to exchange the memory card. The above-described operation is repeated to take the moving image until recording the image is completed for the memory card 28e.

As described above, the moving-image files are continuously recorded in the memory cards set in both of the slots 25 and 26. At this time, while the moving-image file is recorded in the memory card of one of the slots, the memory card of the other slot is exchangeable. In virtue of this, it is possible to take the moving image for a long time by using many memory cards having small capacity, without using the memory card having large capacity.

As shown in FIG. 10, the moving-image files 66 to 70 are recorded in the memory cards 28a to 28e after photographing. File names of DSCF0001a.Avi to “DSCF0001e.Avi” are given to the respective moving-image files 66 to 70. The image data produced by taking the continuous moving image is divided and recorded in the memory cards 28a to 28e. The common file name of “DSCF0001” is used for clarifying the mutual relation of the divided image data. An alphabet representing an order of photographing is added to the end of the file name so as to know this order from the file name.

As mentioned above, the moving-image files produced by taking the continuous moving image are easily distinguished by the file names so that the moving-image files are easily dealt with after photographing. Further, when the moving-image files are combined by using a personal computer or the like after photographing to form the sole moving-image file, it is possible to sort the files on the basis of the file names. Thus, automation of combining the files may be easily performed.

The moving-image file 66 is formed such that the header data 66b and the photographic data 66c are added to the image data 66a. In this photographic data 66c, it is possible to record information representing that the concerned file is one of the moving-image files produced by taking the moving image for a long time. It is also possible to record a relation to the other moving-image file.

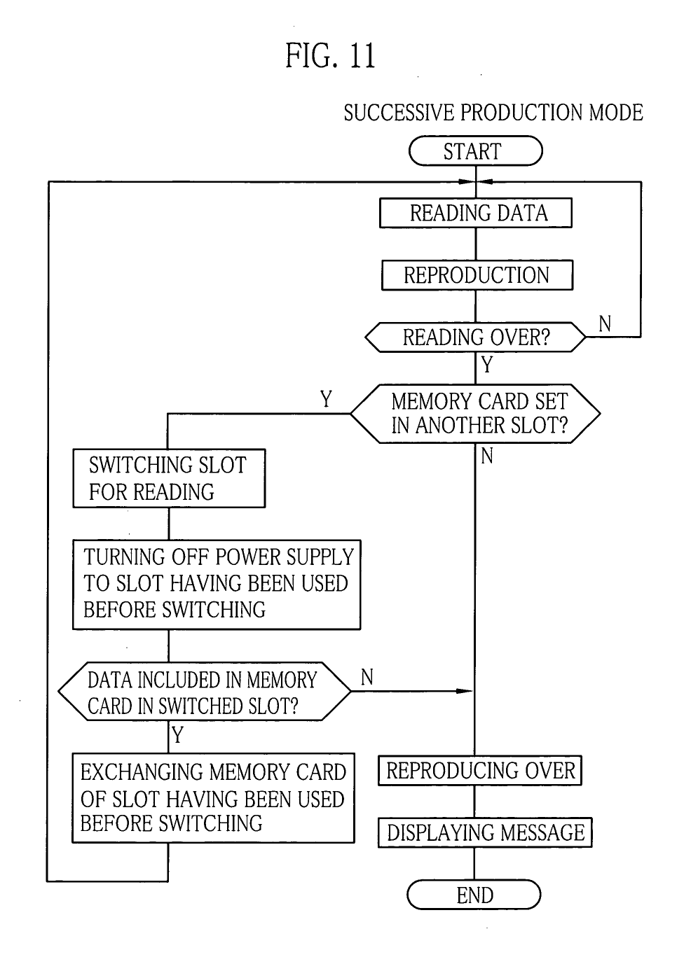

Next, the successive reproduction mode of the camera 2 is described below, referring to the flowcharts of FIGS. 8 and 11. For example, when the data of the memory cards 28a to 28e shown in FIG. 10 is reproduced, the memory cards 28a and 28b, for instance, are inserted into the first and second slots 25 and 26 of the camera 2. It is possible to set the memory cards to the respective slots 25 and 26 in any state of turning on and off the power supply of the camera 2, similarly to the long-time photography mode.

After inserting the memory cards 28a and 28b, the successive reproduction mode is set by operating the mode operation member 13. And then, the memory controller 50 commences to read the moving-image file from the memory card 28a upon operation of the menu button 16 working as a reproduction button. In addition, the memory controller 50 monitors a status of the moving-image file read from the memory card 28a.

The moving-image file 66 read from the memory card 28a is temporarily stored in the RAM of the controller 35 and is inputted into an encoder of the display 37. The encoder encodes the moving-image file to produce a composite signal to be inputted into the LCD driver. Thereupon, the moving image read from the memory card 28a is reproduced on the display monitor 10.

Also under the successive reproduction mode, the power supply is stopped relative to the second slot 26 of the non-operational state while the first slot 25 is operated. Incidentally, regarding which of the first and second slots 25 and 26 is used first for reading the image data, priority may be determined in advance. In another way, the slot to be used first may be determined by comparing the file manes. In the other way, the slot to be used fist may be determined in accordance with the capacity of the memory card. Further, the user may designate the slot before photographing.

When the successive reproduction is performed with the exchange of the memory card, sometimes it becomes difficult to specify the slot for exchanging the memory card next. In view of this, it is preferable to indicate a message of “FIRST SLOT: REPRODUCTION OVER, EXCHANGEABLE” within the message area 65 shown in FIG. 9, similarly to the case of the long-time photography mode. The message area 65 may indicate the status of reproduction, such as “REPRODUCTION STATUS OF FIRST SLOT: 34%”. By this indication, it becomes possible to anticipate the time for exchanging the memory card.

When the reproduction status of the memory card 28a of the first slot 25 progresses, the power control unit 39 commences to supply the power to the second slot 26 to make ready for reading the data from the memory card 28b. When the reproduction of the memory card 28a has been over, the memory controller 50 commences to read the image data from the memory card 28b of the second slot 26. In this way, the moving-image files are successively read from the memory cards of the plural slots. Thus, the moving image taken under the long-time photography mode is easily reproduced in succession.

By the way, in case the memory card is not set in the slot to be used next when the slot for reading is switched, the reproduction is terminated and this situation is indicated on the display monitor 10. Even if the memory card is set in the slot to be used next, the reproduction is similarly terminated and this situation is indicated on the display monitor 10 when the set memory card does not record the moving-image file.

When the reproduction of the memory card 28a of the first slot 25 has been over, the display monitor 10 indicates the message of “FIRST SLOT: REPRODUCTION OVER, EXCHANGEABLE”. After confirming this message, the user exchanges the memory card 28a of the first slot 25 to the memory card 28c. Exchanging the memory card is performed along the same sequence, which is described in the long-time photography mode, so that detailed description thereof is abbreviated.

As described above, the slot of which the memory card is exchangeable is indicated. Thus, it is prevented to forget the exchange. Changing the memory card during the reproduction is performed relative to the slot whose lid is opened by operating the media exchange button 18, similarly to the long-time photography mode. As to the slot currently used for reading the moving-image file, the lid thereof is not opened. Thus, it is prevented to mistakenly exchange the memory card during data access.

When the reproduction of the memory card 28b of the second slot 26 has been over, the moving-image file is successively read from the exchanged memory card 28c of the first slot 25. Meanwhile, the memory card 28b of the second slot 26 is exchanged to the memory card 28d. The above-described operation is repeated and the successive reproduction is performed until the reproduction of the moving-image file of the memory card 28e is over.

While the moving-image file is read from the memory card of one of the slots, the memory card of the other slot is exchanged. It is possible to successively reproduce the moving image taken under the long-time photography mode by using the plural memory cards.

While taking and reproducing the long-time moving image with the many memory cards, the battery of the power source 40 lacks its capacity. In view of this, it is preferable to prepare a plurality of replacement batteries and to ensure a long-term power source by connecting the camera 2 to an AC power source.

In the above embodiment, the lid is opened upon operation of the media exchange button. However, when the recording of the memory card has been completed, the lid of the concerned slot may be automatically opened.

By opening the lid, the slot of which the memory card is exchangeable is notified to the player. However, the slot of the exchangeable state may be notified to the user by ejecting the memory card from the slot. By doing so, the memory card may be exchanged in a second without the ejecting operation. It is possible to realize the automatic rejection of the memory card with comparative ease and at low cost by adding a source of power, which is an actuator and so forth, to the ejecting mechanisms 47 and 48.

The above embodiment relates to the camera provided with the slots in which the memory cards of the same kind are set. The present invention, however, may be adopted to another camera provided with a plurality of slots in which memory cards of different kinds are set.

The above embodiment relates to the digital camera employing the memory card. The present invention, however, may be adopted to a video camera for recording a video signal in a videocassette tape, and a digital video camera for recording the image data in the videocassette tape. Further, the present invention may be adopted to recording and reproduction performed in a video recorder used for recording a television program.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

1. A data management method for an imaging apparatus including an imaging unit for taking a subject to produce image data, and further including first and second slots for setting recording media, said data management method comprising the steps of:
commencing to record the image data in the recording medium set in said first slot;
monitoring available memory of the recording medium set in said first slot while said image data is recorded; and
continuously recording said image data in the recording medium set in said second slot when the available memory of the recording medium set in said first slot has run out.

2. A data management method according to claim 1, further comprising the step of:
giving related file names to image files including said image data recorded in said recording media.

3. A data management method according to claim 1, further comprising the step of:
enabling the recording medium, which is set in the slot except one slot, to be exchanged while accessing the recording medium set in said one slot.

4. A data management method for an imaging apparatus including an imaging unit for taking a subject to produce image data, and further including first and second slots in which recording media for recording the image data are respectively set, said data management method comprising the steps of:
commencing to read the image data from the recording medium set in said first slot;
monitoring a readout status of the recording medium set in said first slot while reading said image data; and
commencing to read the image data from the recording medium set in said second slot when said image data has been fully read from the recording medium set in said first slot.

5. A data management method according to claim 4, further comprising the step of:
enabling the recording medium, which is set in the slot except one slot, to be exchanged while accessing the recording medium set in said one slot.

6. An imaging apparatus comprising:
an imaging unit for taking a subject to produce image data;
a plurality of slots including first and second slots, in which recording media for recording said image data are set; and
a media controller for selectively using said slots to perform recording and reading of said image data relative to said recording media set in the respective slots, said media controller continuously recording the image data in the recording medium set in said second slot when available memory of the recording medium set in said first slot has run out while recording the image data in this recording medium.

7. An imaging apparatus according to claim 6, wherein said media controller enables the recording medium, which is set in the slot except one slot, to be exchanged while accessing the recording medium set in said one slot.

8. An imaging apparatus according to claim 7, further comprising:
a power controller for stopping power supply to the slot, in which the recording medium to be exchanged is set, at the time of exchange of said recording medium.

9. An imaging apparatus according to claim 7, further comprising:
a display for indicating the slot of which the recording medium is exchangeable.

10. An imaging apparatus according to claim 7, further comprising:
a media protector for preventing said recording medium from being ejected from said slot during access, said media protector allowing said recording medium of a non-operational state to be ejected from said slot.

11. An imaging apparatus according to claim 10, wherein said media protector comprising:
a plurality of lid members for respectively opening and closing media inlets of the respective slots;
a plurality of operation mechanisms for respectively opening and closing said lid members; and
a lid-operation controller for actuating said operation mechanism of the slot, in which the recording medium of the non-operational state is set, to open the corresponding lid member.

12. An imaging apparatus according to claim 11, wherein said opened lid member is closed after a predetermined period.

13. An imaging apparatus according to claim 7, further comprising:
a plurality of ejecting mechanisms for ejecting said recording media from the respective slots; and
an eject button for actuating said ejecting mechanism of the slot, in which the recording medium of a non-operational state is set, to eject this recording medium from said slot.

14. An imaging apparatus comprising:
an imaging unit for taking a subject to produce image data;
a plurality of slots including first and second slots, in which recording media for recording said image data are set; and
a media controller for selectively using said slots to perform recording and reading of said image data relative to said recording media set in the respective slots, said media controller commencing to read the image data from the recording medium set in said second slot when the image data has been fully read from the recording medium set in said first slot.

15. An imaging apparatus according to claim 14, wherein said media controller enables the recording medium, which is set in the slot except one slot, to be exchanged while accessing the recording medium set in said one slot.

16. An imaging apparatus according to claim 15, further comprising:
a power controller for stopping power supply to the slot, in which the recording medium to be exchanged is set, at the time of exchange of said recording medium.

17. An imaging apparatus according to claim 15, further comprising:
a display for indicating the slot of which the recording medium is exchangeable.

18. An imaging apparatus according to claim 15, further comprising:
a media protector for preventing said recording medium from being ejected from said slot during access, said media protector allowing said recording medium of a non-operational state to be ejected from said slot.

19. An imaging apparatus according to claim 18, wherein said media protector comprising:
a plurality of lid members for respectively opening and closing media inlets of the respective slots;
a plurality of operation mechanisms for respectively opening and closing said lid members; and
a lid-operation controller for actuating said operation mechanism of the slot, in which the recording medium of the non-operational state is set, to open the corresponding lid member.

20. An imaging apparatus according to claim 19, wherein said opened lid member is closed after a predetermined period.

21. An imaging apparatus according to claim 15, further comprising:
a plurality of ejecting mechanisms for ejecting said recording media from the respective slots; and
an eject button for actuating said ejecting mechanism of the slot, in which the recording medium of a non-operational state is set, to eject this recording medium from said slot.
